(19) United States
(12) Patent Application Publication
(10) Pub. No.: US 2021/0108675 A1
(43) Pub. Date: Apr. 15, 2021

(54) Composite Vehicle Driveshaft Assembly with Bondable End Components

(71) Applicant: Composite Drivelines, LLC, West Allis, WI (US)

(72) Inventors: James Lee Dorman, West Allis, WI (US); Daniel P. Lentsch, Milwaukee, WI (US); Gregg Piper, Wauwatosa, WI (US)

(21) Appl. No.: 17/070,525

(22) Filed: Oct. 14, 2020

Related U.S. Application Data
(60) Provisional application No. 62/915,381, filed on Oct. 15, 2019.
(60) Provisional application No. 62/915,390, filed on Oct. 15, 2019.
(60) Provisional application No. 62/915,401, filed on Oct. 15, 2019.
(60) Provisional application No. 62/915,427, filed on Oct. 15, 2019.

(51) Int. Cl. F16C 3/02; F16D 1/068; F16D 3/38

(52) U.S. Cl. CPC F16C 3/026; F16C 2326/06; F16D 3/387; F16D 1/068

(57) ABSTRACT

A composite vehicle driveshaft assembly includes a composite tube and a bondable end component that is bonded to one of the ends of the tube. The bondable end component may include a flex plate end yoke, a slip joint, or a stub shaft that may provide a modular support to which other end or joint components can mount. The modular end component may include an inner sleeve that is concentrically received in the end of the tube. The sleeve has an outer peripheral surface that faces the inner peripheral surface of the tube with a cavity formed therebetween. An adhesive injection passage is formed in the end component and extends at an acute angle from an inlet that is formed in an axial surface of the flex plate end yoke to an outlet that is formed in the outer peripheral surface of the sleeve and that opens into the cavity. Also disclosed is a method of bonding an end component of such a driveshaft assembly to a composite tube.

### CROSS-REFERENCE TO RELATED APPLICATIONS

This application claims the benefit of each of the co-pending provisional patent applications U.S. App. No. 62/915,381 filed on Oct. 15, 2019 and entitled “Composite Vehicle Driveshaft Assembly With Bonded Flex Plate End Yoke,” U.S. App. No. 62/915,390 filed on Oct. 15, 2019 and entitled “Composite Vehicle Driveshaft Assembly With Slip Joint,” U.S. App. No. 62/915,401 filed on Oct. 15, 2019 and entitled “Composite Vehicle Driveshaft Assembly With Modular End Assembly,” and U.S. App. No. 62/915,427 filed on Oct. 15, 2019 and entitled “Composite Vehicle Driveshaft Assembly,” the entire contents of which are hereby expressly incorporated by reference into the present application.

### FIELD OF THE INVENTION

The invention relates generally to vehicle propel shafts or driveshafts that include one or more tubular sections made in part from composite materials. The invention additionally relates to a composite vehicle driveshaft assembly with a bondable end component such as a flex plate end yoke, a slip joint system, a CV (constant velocity) joint, a U-joint (universal joint), or the like, bonded to an end of a composite tube.

### BACKGROUND OF THE INVENTION

Composite driveshafts are available, which have resulted from efforts to provide weight reduction for rotating assemblies. Such driveshafts have a long tubular section that is formed from resin-bound spiral wound filaments and end components or couplers or joints in the form of metallic driveline components such yokes, flex joints, etc. However, composite driveshaft assemblies have not been widely implemented for vehicle use. Designing composite driveshaft assemblies with composite tubes that connect to metallic components such as conventional vehicle driveline components presents numerous challenges.

For example, the composite tubes operate in substantially different use environments than other driveshaft applications. Vehicle driveshafts operate in heat envelopes that expose them to high operating temperatures and large temperature variations, operate at high rotational speeds and with large rotational speed variations, and experience substantial torsional loading conditions such as shock-loads and/or other extreme torque spikes, and are subject to stricter diameter and other size constraints.

Connecting the composite tubes to other driveline components such as flex plate yokes presents an especially difficult challenge. It is difficult to design and assemble joints, fittings, or adapters to transition from the composite tubes to flex plate end yokes, a slip joint system components, CV joint components, U-joint yokes or other end couplers or end components that can maintain connection integrity with the composite tubes while handling these operating conditions and that are also sufficiently manufacturable and economical. Since composite tubes cannot be welded, they must be bonded to the end coupler. One approach is to bond the inner surface of the end of the composite tube to an outer surface of the end coupler. Bores must be provided in the tube and/or the end coupler to permit injection of an adhesive therebetween. However, drilling radial holes in the tube weakens the tube. The holes may also be prone to plugging with loose filaments, hindering or preventing the injection of adhesives.

The need therefore has arisen to provide a composite driveshaft assembly having a composite tube that is securely and reliably bonded to a flex plate end yoke without unacceptably weakening the composite tube or the end yoke.

### SUMMARY OF THE INVENTION

In accordance with a first aspect of the invention, a composite vehicle driveshaft assembly includes a composite tube with a tube sidewall that extends longitudinally between input and output ends of the tube. A bondable end component is bonded to one of the ends of the tube.

According to one aspect of the invention, a flex plate end yoke is bonded to one of the ends of the tube. The flex plate yoke has an inner sleeve that is concentrically received in the associated end of the tube. The sleeve has an outer peripheral surface that faces the inner peripheral surface of the tube with a cavity formed therebetween. An adhesive injection passage is formed in the flex plate yoke and extends at an acute angle from an inlet formed in an axial surface of the flex plate yoke to an outlet formed in the outer peripheral surface of the sleeve. The angle of the injection passage is selected to connect to the cavity without removing materials in amounts and at locations that unacceptably weaken the flex plate yoke. Because the outlet intersects the surface of the sleeve at an acute angle rather than perpendicularly, the outlet is elliptical in shape, providing a relatively large opening through which adhesive can flow into the cavity.

In accordance with another aspect of the invention, a method of bonding a flex plate end yoke of a driveshaft assembly to a composite tube of the driveshaft assembly includes injecting an adhesive at an acute angle from an axial surface of the flex plate end yoke, through an opening in an outer peripheral surface of a sleeve of the flex plate end yoke, and into a cavity formed between the outer peripheral surface of the sleeve of the flex plate end yoke and an inner peripheral surface of the composite tube. The adhesive then cures.

In accordance with a first aspect of the invention, a composite vehicle driveshaft assembly is provided that accommodates suspension articulation by allowing telescopic movement of a slip joint in the driveshaft assembly. The telescopic movement of the driveshaft slip joint allows passive variation of the driveshaft assembly's length to accommodate arcing or pivot travel of the driveshaft assembly in response to substantially linear movement of various drivetrain and suspension components.

In accordance with another aspect of the invention, the slip joint may include a splined sleeve bonded to a composite tube. A splined slip yoke is received in the splined sleeve for passive axial reciprocation of the slip yoke while the slip yoke and sleeve are locked in rotation unison with each other.

In accordance with a first aspect of the invention, a composite vehicle driveshaft assembly is provided that with a modular end assembly that allows assembly of any of a variety of end assemblies and corresponding driveline joints with fewer inventoried parts.

In accordance with another aspect of the invention, the modular end assembly may include a splined sleeve and a splined stub shaft is received in the splined sleeve. The splined sleeve may be bonded to a composite tube.

In accordance with another aspect of the invention, a permanent connection may be formed between the stub shaft and sleeve. This may be achieved by, for example, a spring ring that is held in compression on the stub shaft until aligning with a receiving feature of the sleeve such as an internal groove, at which point the spring ring releases into the sleeve's receiving feature and mechanically locks the stub shaft and sleeve to each other.

Also disclosed is a method of fabricating a composite driveshaft assembly constructed in accordance with one or more of the above-aspects.

These and other features and aspects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the scope of the invention.

### BRIEF DESCRIPTION OF THE DRAWINGS

FIG. 1 schematically illustrates a vehicle with a composite vehicle driveshaft assembly constructed in accordance the invention;

FIG. 2 is a sectional elevation view of the driveshaft assembly of FIG. 1 implementing a first embodiment of an end component;

FIG. 3 is a fragmentary sectional view of a portion of the driveshaft assembly of FIG. 2, showing the connection of the end component as a flex plate end yoke of the driveshaft assembly to a composite tube of the assembly;

FIG. 4 is an enlarged fragmentary sectional view of a portion of the driveshaft assembly of FIG. 1, showing the connection of the flex plate end yoke to the composite tube in greater detail;

FIG. 5 is a perspective view of the flex plate end yoke of the composite driveshaft assembly of FIGS. 1-3;

FIG. 6 is an elevation view of the flex plate end yoke of FIG. 5;

FIG. 7 is a sectional elevation view of the flex plate end yoke of FIGS. 5 and 6;

FIG. 8 is an outer end view of the flex plate end yoke of FIGS. 4-6; and

FIG. 9 is an inner end view of the flex plate end yoke of FIGS. 4-7.

FIG. 10 is a sectional elevation view of the driveshaft assembly of FIG. 1 implementing another embodiment of an end component;

FIG. 11 is a fragmentary sectional view of a portion of the driveshaft assembly of FIG. 10, showing the connection of the end component as a slip joint sleeve of the driveshaft assembly to a composite tube of the assembly;

FIG. 12 is a cross-sectional side elevation view of the slip joint sleeve of FIG. 11;

FIG. 13 is a side elevation view of a slip shaft of the slip joint of FIG. 10;

FIG. 14 is an exploded partially cross-sectional view of components of the slip joint of FIG. 10;

FIG. 15 is an exploded view of the slip joint of FIG. 10;

FIG. 16 is a cross-sectional view of the slip joint of FIG. 10;

FIG. 17 is a cross-sectional elevation view of the driveshaft assembly of FIG. 1 implementing another embodiment of an end component as a modular end assembly;

FIG. 18 is a fragmentary sectional view of a portion of the driveshaft assembly of FIG. 17, showing the connection of the end component as a modular end assembly sleeve of the driveshaft assembly to a composite tube of the assembly;

FIG. 19 is a cross-sectional side elevation view of the modular end assembly sleeve of FIG. 18;

FIG. 20 is a side elevation view of a modular end assembly shaft of the modular end assembly of FIG. 17;

FIG. 21 is an exploded partially cross-sectional view of components of the modular end assembly of FIG. 17;

FIG. 22 is an exploded view of the modular end assembly of FIG. 17;

FIG. 23 is cross-sectional view of the modular end assembly of FIG. 17;

FIG. 24 is schematic representation of interchangeable components of the modular end assembly of FIG. 17;

FIG. 25 is a flow diagram representing a surface preparation phase used in producing a composite vehicle driveshaft;

FIG. 26 is a flow diagram representing an assembly phase used in producing a composite vehicle driveshaft; and

FIG. 27 is a flow diagram representing a bonding phase used in producing a composite vehicle driveshaft.

Before the embodiments of the invention are explained in detail, it is to be understood that the invention is not limited in its application to the details of construction and the arrangement of the components set forth in the following description or illustrated in the drawings. The invention is capable of other embodiments and of being practiced or carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE PREFERRED EMBODIMENTS

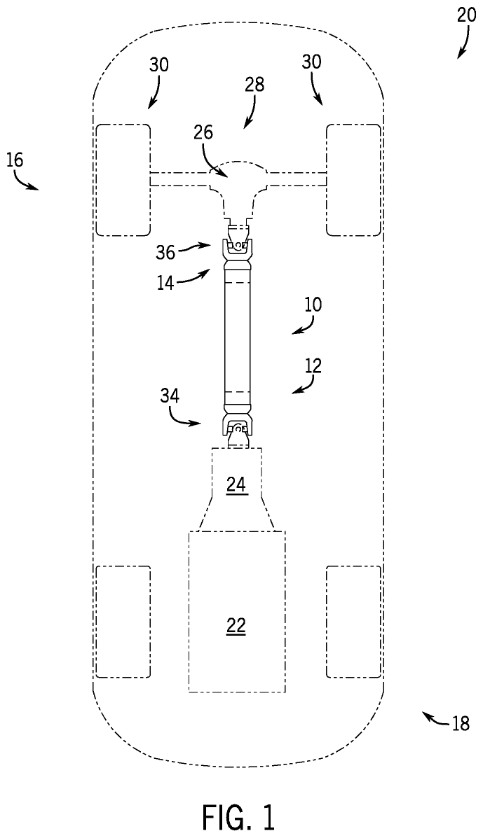

Referring now to the drawings and initially to FIG. 1, a composite vehicle driveshaft assembly 10 is illustrated as installed in a vehicle, which vehicle is represented here as an automobile 16. Automobile 16 has front and rear ends 18, 20 and a powertrain that includes a prime mover such as an engine 22. A transmission 24 receives power from the engine 22 and delivers it downstream through the composite vehicle driveshaft 10 to a differential 26 that delivers the power through a drive axle 28 to a pair of drive wheels 30. The illustrated driveshaft assembly 10 has a composite tube 40 and bondable end components 12 and 14 represented as end couplers or end joints 12 and 14 respectively connecting the driveshaft front end 34 to the transmission 24 and the driveshaft rear end 36 to the differential 26. It is understood that instead of the transmission 24 and differential 26, the composite vehicle driveshaft assembly 10 may instead transmit power from the engine 22 to a transaxle that combines a transmission and drive axle.

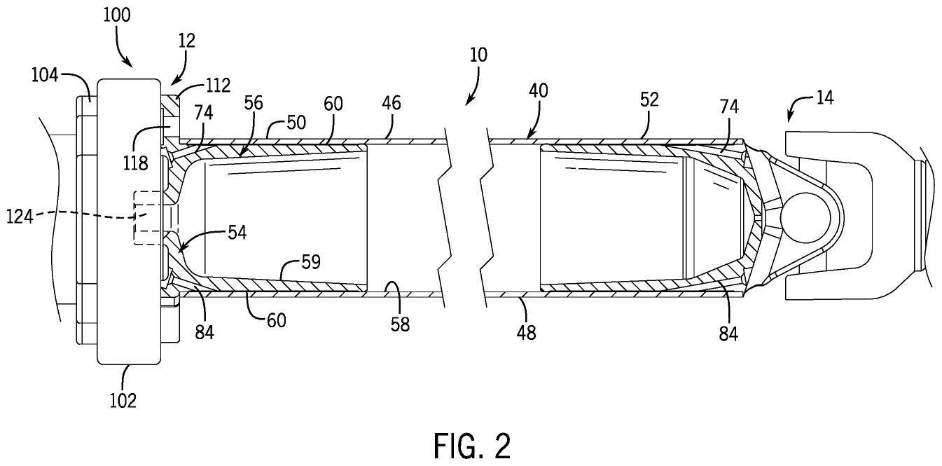

Referring now to FIGS. 2-4, composite vehicle driveshaft 10 includes a composite tube 40 that defines an intermediate portion of the composite vehicle driveshaft assembly 10 and that is bonded to the end components or couplers 12 and 14 at its front and back ends, respectively. Composite tube 40 may be a cylindrical hollow tube made from a composite material(s), including fibrous and resin materials components. Composite tube 40 has a body 46 with inner and outer peripheral surfaces 58 and 48 and a pair of ends, shown as front and rear tube ends 50, 52. The composite tube 40 may be a product of a filament winding process. The filament winding process may include wrapping or winding a filament(s) or string(s), for example, single fiber strings that are soaked in a resin around a steel or other sufficiently rigid core or mandrel. The fibers may include, for example, carbon fiber and/or fiberglass fibers. The fiber soaking may provide a wet laminate or the fiber(s) may be pre-soaked in a resin to provide what is sometimes referred to in the industry as “pre-preg materials”. Regardless of the particular fiber soaking procedure, after the filament winding process, the wound filament(s) or wound tubular product may then oven-heat cured or ambient temperature cures, explained in greater detail elsewhere herein.

Tube lengths, diameters, and thicknesses may vary from application to application and with designer preference, with thinner tubes typically being used for shorter driveshafts and thicker tubes being used for longer driveshafts. Tube lengths of 10″ to 70″ (254 mm to 1780 mm) are typical for automotive driveshaft application. Tube inner diameters may vary from about 2.5″ to 5″ (65 mm to 125 mm). Tube thicknesses may vary from about 0.125″ to 0.155″ (31.75 mm to 39.37 mm), with thicker tubes being more typical for longer driveshafts. Tube diameter for automotive applications typically will be 2.5″ (63.5 mm), 3″ (76.2 mm), or 3.5″ (88.9 mm), depending on the specific application.

Regardless of the particular configuration of composite tube 40, composite tube 40 has input and output ends, represented here as front and rear tube ends 50, 52 that are bonded to the end components or couplers 12, 14. The bonding may connect components made of dissimilar materials to each other. This allows a non-metallic component, such as the composite tube 40, to provide a substantial or a majority portion of the length of the composite vehicle driveshaft 10 while also providing metallic component connections through the joints at the interfaces between the driveshaft front and rear ends 34, 36 and the transmission 24 and differential 28.

Referring to FIG. 2, at least one of the end components or couplers 12 and 14 takes the form of a flex plate end yoke bonded to the associated end of the composite tube 40. At least the end component or coupler 12 is a flex plate end yoke in this embodiment. The other component or coupler 14 could be a flex plate yoke, a different yoke, a different end coupler or end joint such as a Universal joint (U joint), a CV (constant-velocity), or a slip yoke or other splined coupler. Coupler 14 is illustrated as a bond yoke of a U-joint in this embodiment.

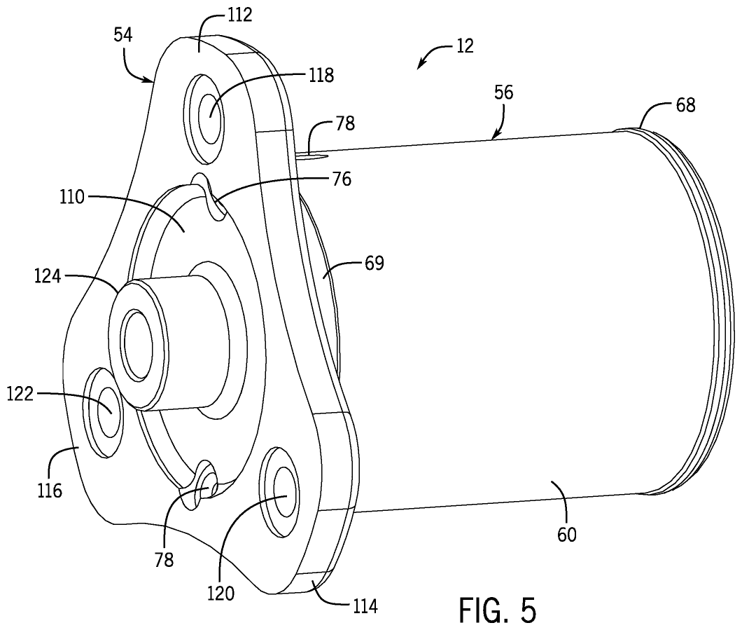

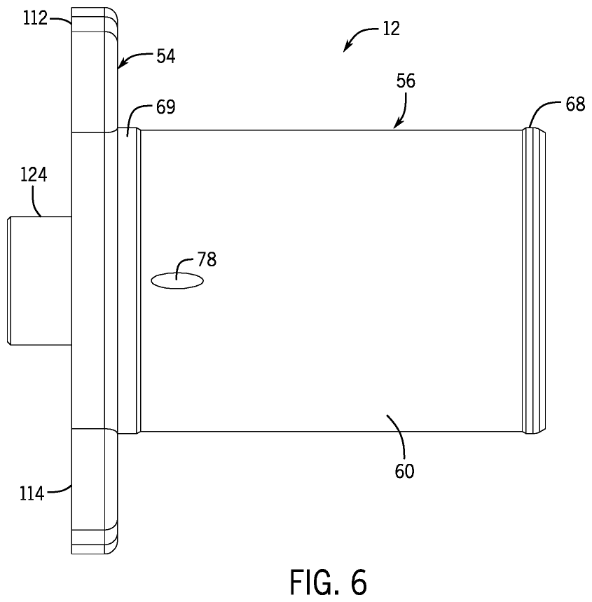

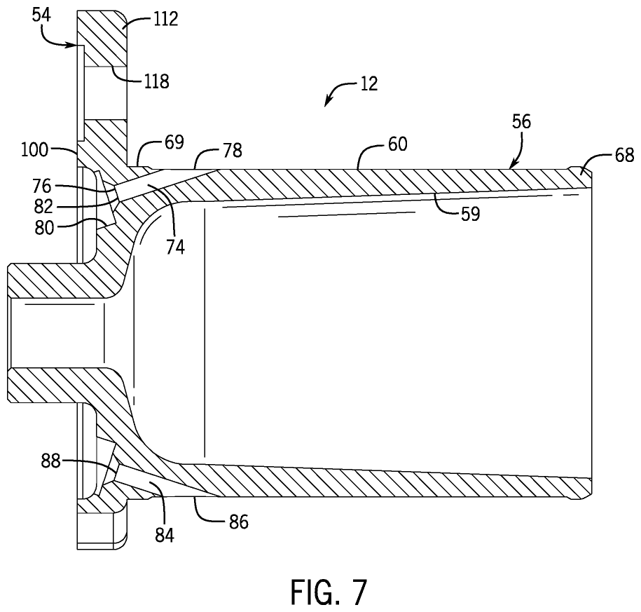

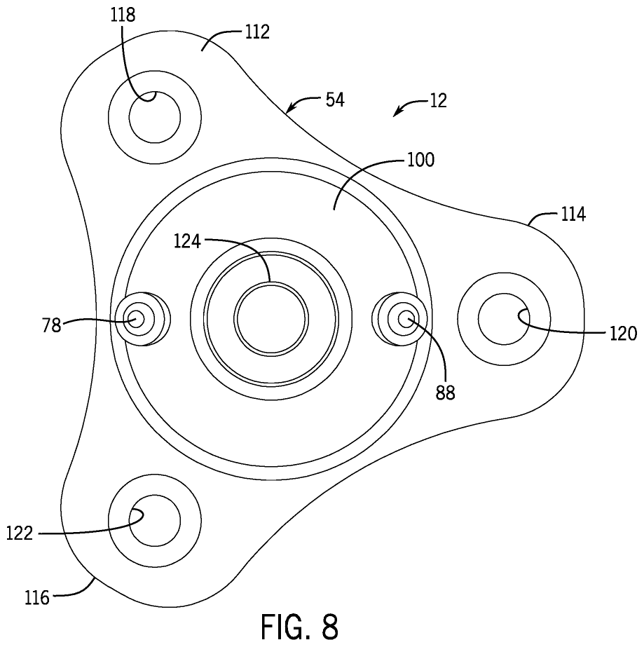

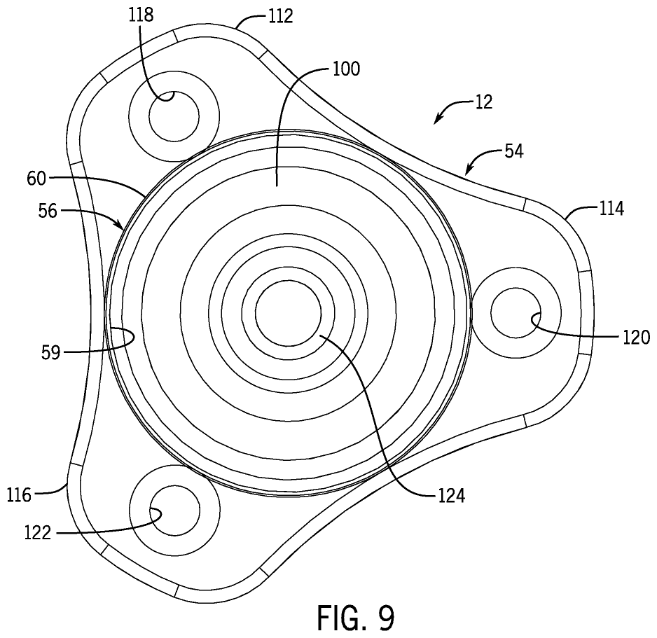

Still referring to FIG. 2, flex plate end yoke 12 is connected to (and technically forms part of) a flex yoke 100. Flex yoke 100 includes the metal flex plate end yoke 12, a center rubber flex disk or “giubo” 102, and a second flex plate end yoke 104 connected to another component of the driveline, in this case the transmission 24. (FIG. 1). Yoke 12 has an outer coupler 54 and an inner tubular sleeve 56 formed from a single metal casting, typically aluminum or steel. Referring to FIGS. 5-9, the outer coupler 54 has a center hub 110 and three circumferentially spaced flanges 112, 114, and 116 extending radially outwardly from the hub 100. Each flange 112, 114, and 116 has a countersunk through-bore 118, 120, 122 for receiving a bolt (not shown) that extends through the bore and into a respective bushing (not shown) in the flex disk 102. Six such holes are provided in the flex disk 102 with alternating holes receiving bolts associated with one of the two flex yokes 12 and 104 in a known manner. A shaft 124 extends axially from the center of the hub 100 for engaging a center hole in the flex disk 102.

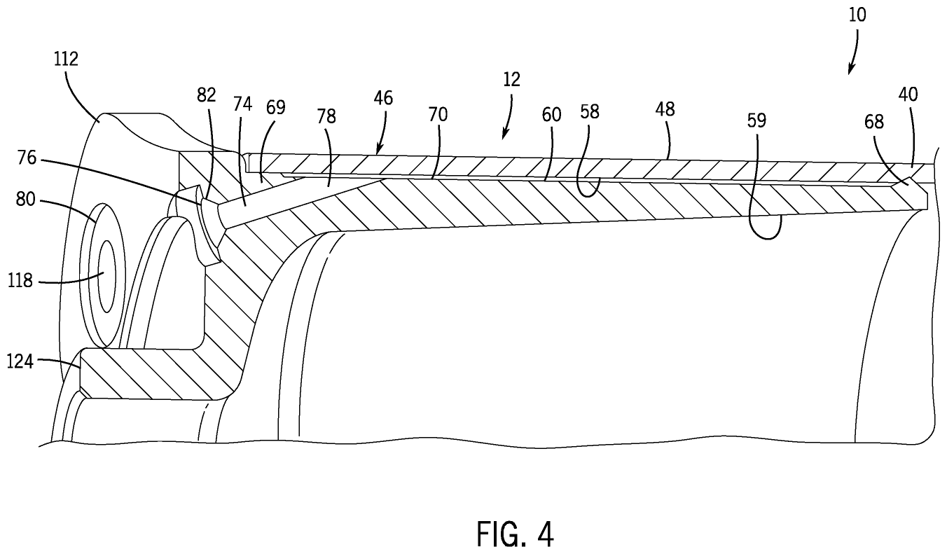

Referring to FIGS. 2-9, the sleeve 56 has inner and outer peripheral surfaces 59 and 60. The sleeve 56 fits concentrically in the front tube end 50 of tube 40 so that the inner peripheral surface 58 of the composite tube 40 faces toward the outer peripheral surface 60 of the sleeve 56. Sleeve 56 may be aluminum or made from a ferrous metal such as steel. As best seen in FIG. 4, a cavity 70 is formed between the inner surface 58 of the composite tube 40 and the outer surface 60 of the sleeve 56 for receiving adhesive. Cavity 70 is sealed at its axial ends by structures extending radially between the sleeve 56 and the composite tube 40. In the illustrated embodiment, these structures take the form of inner and outer lands 68 and 69 that extend radially outwardly from the outer circumferential surface 60 of the sleeve 56 to the inner peripheral surface of the composite tube 40, with the lands 68 and 69 being longitudinally spaced from each other along the sleeve 56. The lands 68 and 69 engage the inner peripheral surface 58 of the composite tube 40 through a snug fit, which may be an interference fit that requires press-assembly. Such a fit ensures concentricity of the sleeve 56 within the composite tube 40 by coaxially locating the sleeve 56 within the composite tube 40 in a manner that prevents radial offset or angular tilting of the sleeve 56 with respect to a longitudinal axis of the tube 40.

Cavity 70 is filled with an adhesive (not shown) to bond the sleeve 56 to the composite tube 40. The adhesive may be any of a variety of industrial, aerospace, or other suitable adhesives, epoxies, or other bonding agents, such as a suitable methacrylate adhesive or various one available from 3M® under Scotch-Weld™ and various other tradenames. The bond between the sleeve 56 and the composite tube 40 may allow for suitable automotive applications and other high torque applications, including high performance vehicle applications that require driveshafts with high torque capacities. The bonding strength between the sleeve 56 and the composite tube 40 may provide torque capacities within a range of at least about 300 lb./ft of torque capacity up to about 80,000 to 100,000 lb./ft of torque capacity of the composite vehicle driveshaft 10 without bond failure between the sleeve 56 and the composite tube 40.

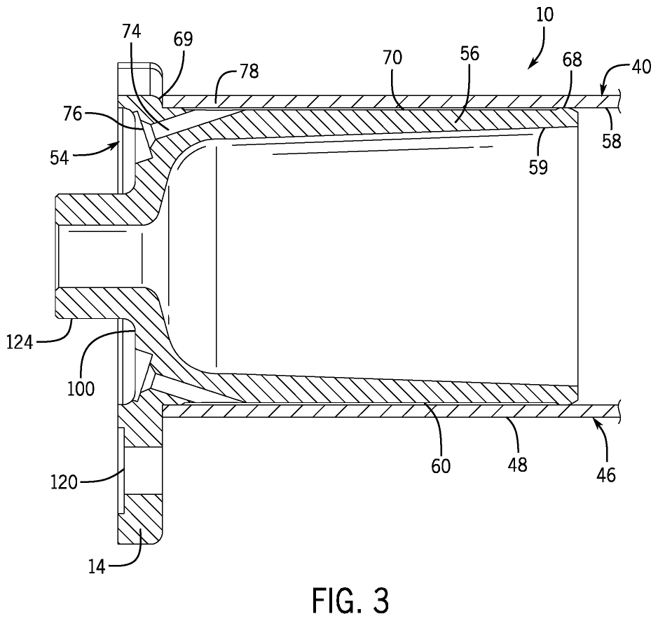

Referring to FIGS. 3, 4, and 7, at least one bore or adhesive injection passage 74 is provided in the flex plate end yoke 12 for the injection of the adhesive into the cavity 70 during an adhesive injection procedure. The adhesive injection passage 74 is shown here with an adhesive inlet 76 located axially beyond the end of the composite tube 40 and an adhesive outlet 78 opening into the cavity 70. For a 90 mm outside diameter sleeve, the passage may be between 2 mm and 7 mm in diameter and, more typically, is 4 mm in diameter. The passage 74 extends linearly at an acute angle relative to the axial centerline of the composite driveshaft assembly 10 from an inlet 76 formed in an axial end surface of the flex plate end yoke 12 to an outlet 78 formed in the outer peripheral surface of the sleeve 56 within the cavity 70. The slope of the angle may vary from application to application. Ideally, it should be as shallow as practical so as to maximize the area of the elliptical outlet 78 without unacceptably weakening the flex plate end yoke by removing too much material in aggregate or in the vicinity of a given surface or, in the alternative, having to undesirably add additional mass to the flex plate end yoke to accommodate the shallow passage. Angles of 5 degrees to 20 degrees are typical. The illustrated passage 74 extends at an angle of 18 degrees and is 17.5 mm long.

The location of the inlet 76 on the hub 100 of the flex plate end yoke 12 negates the need to drill into the composite tube 40. The inlet 76 may be stepped or otherwise shaped to mate with an injection nozzle of a given size and shape to inhibit or prevent adhesive leakage past the perimeter of the fill nozzle. In the illustrated embodiment, the inlet 76 includes an outer cylindrical counterbore 80 and an inner frustoconical countersink 82 connecting the counterbore 80 to the interior of the passage 74.

As mentioned above, the outlet 78 of passage 74 is elliptical or ovoid rather than circular, despite the fact that the passage 74 is circular, due to the fact that the passage 74 intersects the outer peripheral surface 60 of the sleeve 56 at an acute angle rather than perpendicularly. The outlet 78 thus has a relatively large surface area and axial extent when compared to those of a circular outlet, facilitating the flooding of the cavity 70 when adhesive is injected through the passage 74 from the inlet 76. In the present example in which the passage has a diameter of 4 mm and extends at an angle of 18 degrees, the outlet 78 has an area of about 42.5 mm², significantly larger than the 12.5 mm² opening that would be formed from a circular outlet.

Still referring to FIGS. 3, 4, and 7, a second, bleed passage 84 is formed in flex plate end yoke 12 at a location that is spaced peripherally from the injection passage 74. Bleed passage 84 is configured to vent or release air from cavity 70 during the adhesive injection procedure. The bleed passage 84 is most effective when spaced 180 degrees from the injection passage 74, though spacings of considerably fewer and/or additional bleed passages 84 are certainly possible. The bleed passage 84 extends linearly at an acute angle relative to the axial centerline of the composite shaft assembly 10 from an inlet 86 formed in the outer peripheral surface 60 of the sleeve 56 within the cavity 70 to an outlet 88 formed in an axial end surface of the hub 100 of the flex plate end yoke 12. This angle may be within the same range relative to the axial as the angle of the injection passage 74 and, most typically, will be the same as the angle of the injection passage 74, i.e., between 5 degrees and 20 degrees and most typically of about 18 degrees. The location of the outlet 88 on the hub 100 of the flex plate end yoke 12 negates the need to drill into the composite tube 40. The outlet 88 is shown as being counterbored and countersunk such that, if desired, the passage 84 could be used as the injection passage, in which case the passage 74 could function as the bleed passage. Stated another way, the passages 74 and 84 function interchangeably.

Alternatively, or instead of this arrangement, two or more opposed ports or bleed passages could be provided that are each spaced in opposite directions about 150° to 175° from the adhesive injection passage 74.

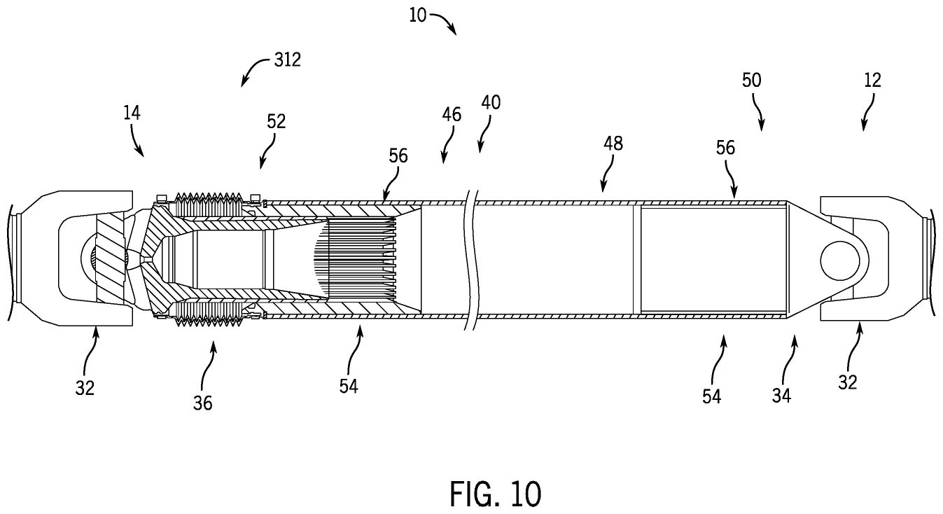

Referring generally to FIGS. 10-16, various components of a slip joint embodiment are shown, with numerous components, structures, and features of that are common with or substantially analogous to those of the flex plate embodiment(s) of FIGS. 2-9, whereby relevant portions of those descriptions are applicable here with respect to FIGS. 10-16.

Referring now to FIG. 10, in this embodiment, bondable end component 14 is shown here in the form of a slip joint 312 that may be implemented as a multi-component arrangement with its components connected in a manner that allows torque transmission through the joint while allowing an overall length of driveshaft assembly 10 to passively vary in response to conditions experienced by automobile 16, such as suspension articulation. Each slip joint 312 has a base shown as a sleeve 56 of the slip joint 312.

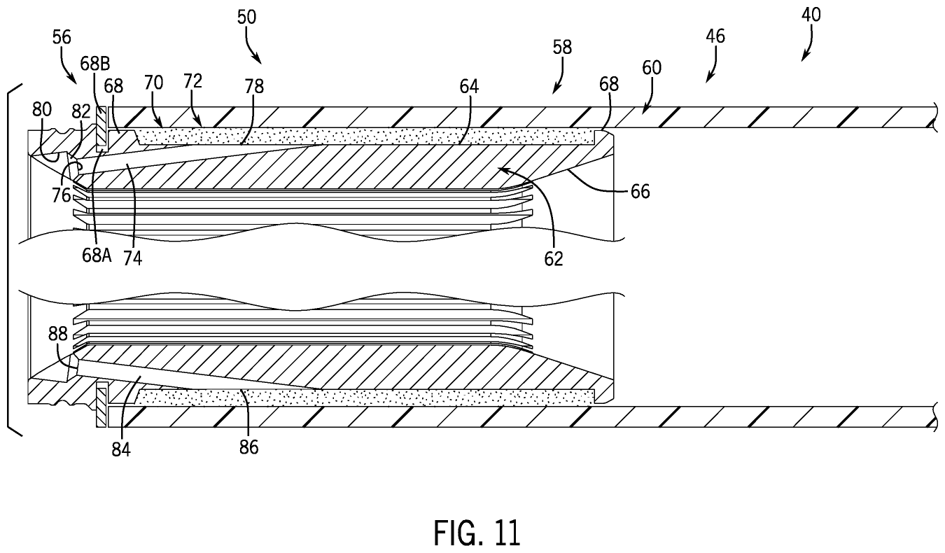

Referring now to FIG. 11, the sleeve 56 may be pressed axially less than entirely into the tube 40, for example, with some of the outer land 68 protruding somewhat from the outer end of tube 40. A groove 68A may extend radially into the outer land 68 and may be configured hold a retainer such as an external snap-ring shown as snap-ring 68B. The snap-ring 68B may abut an outer edge or end surface of the tube 40 to optionally longitudinally or axially register the sleeve 56 and tube 40 with respect to each other. Although contact may be made between the snap-ring and an end face of tube 40, it is understood that snap-ring 68B may bend or move by axial deflection relative to sleeve 56. Snap-ring 68B may also move within groove 68A, such as being able to rotate or slide side-to-side in axial translation om the groove 68A relative to the sleeve 68A. Movement of snap-ring 68B can occur, for example, during initial contact with tube 40 or upon contact with debris or the like, at which point the movement of snap-ring 68 may absorb some of the energy of such collision that would otherwise by transmitted to the end face of tube 40. This allows the snap-ring 68B to provide a resilient bearing surface that covers and can move with respect to an end face of the composite tube. Other retainers or intermediate engaging structures such as an O-ring or the like may engage both the sleeve 56 and the tube 40, if longitudinal or axial registration is desired. However, longitudinal or axial registration of the sleeve 56 and tube 40 is not essential, so the sleeve may be simply pressed into the tube 40 and located with the pressing tool(s), without any such ancillary retainer, seal, or other component. In one example, the sleeve 56 may be pressed substantially fully into the tube 40 to provide a flush or nearly flush end-fit of the sleeve 56 in the tube 40.

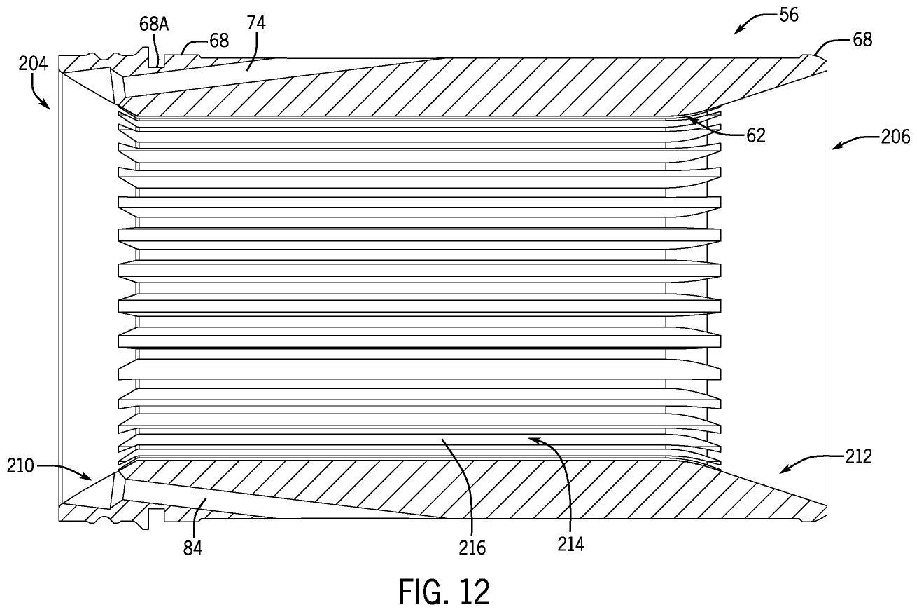

Referring now to FIG. 12, slip joint sleeve 56 is shown here as hollow, with an outer end opening 204 and an inner end opening 206 and multiple interior segments that are axially adjacent each other that are defined by different or varying diameters or steps along a sleeve inner circumferential surface 62. End taper segments 210, 212 are defined at the outer openings on opposite sides of a sleeve splined segment 214 defined at a portion of the sleeve inner circumferential surface 62 with splines 216 that extend into for from the sleeve inner circumferential surface 62.

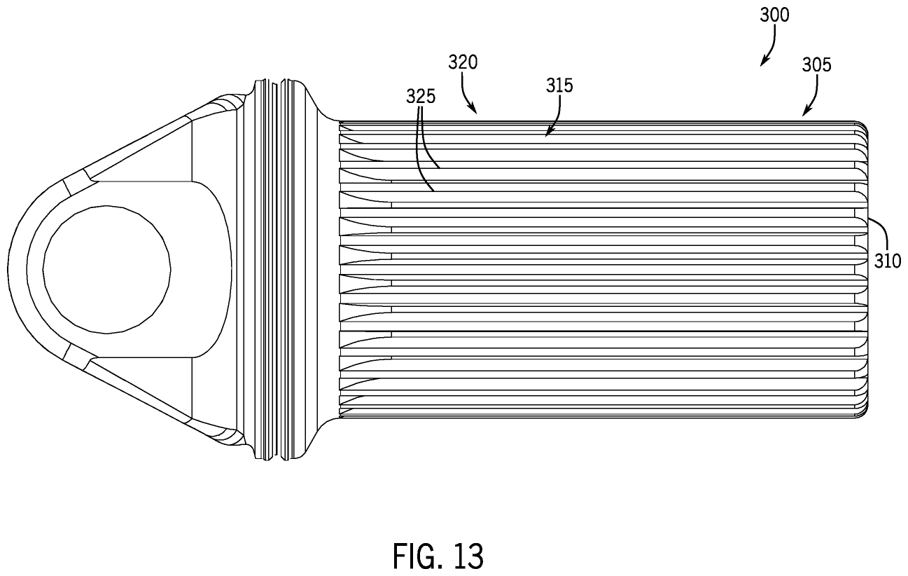

Referring now to FIG. 13, the slip joint includes slip shaft 300 that cooperates with the sleeve 56 (FIG. 12) or other base to allow torque transmission through the joint and simultaneous passive length adjustment or variation of driveshaft assembly 10 (FIG. 1). Slip shaft 300 includes slip shaft base 305, the end of which defines inner end 310 of slip shaft 300. Slip shaft base 305 includes splined shaft 315 that define a slip shaft base splined segment 320 with external splines 325 that extend into or from an outer circumferential surface of splined shaft 315. Slip shaft 300 is shown here configured as a slip yoke with a yoke 330 at its outer end, which cooperates with components of and partially defines a U-joint.

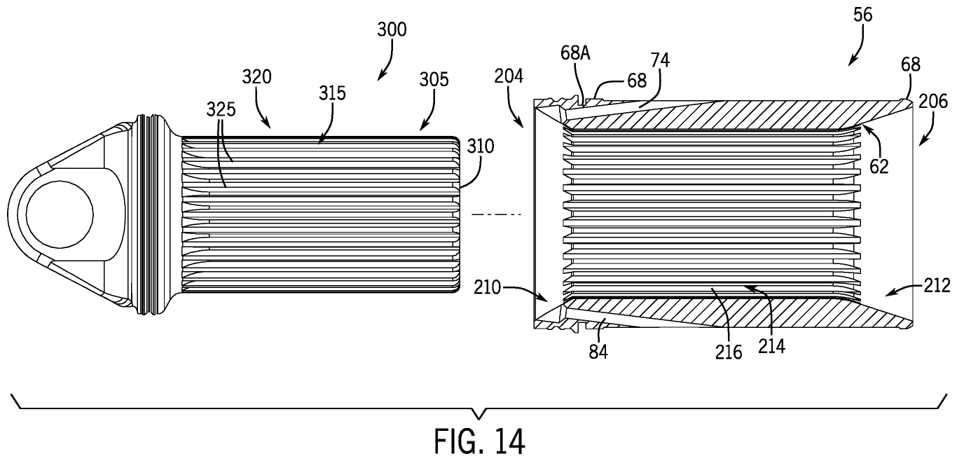

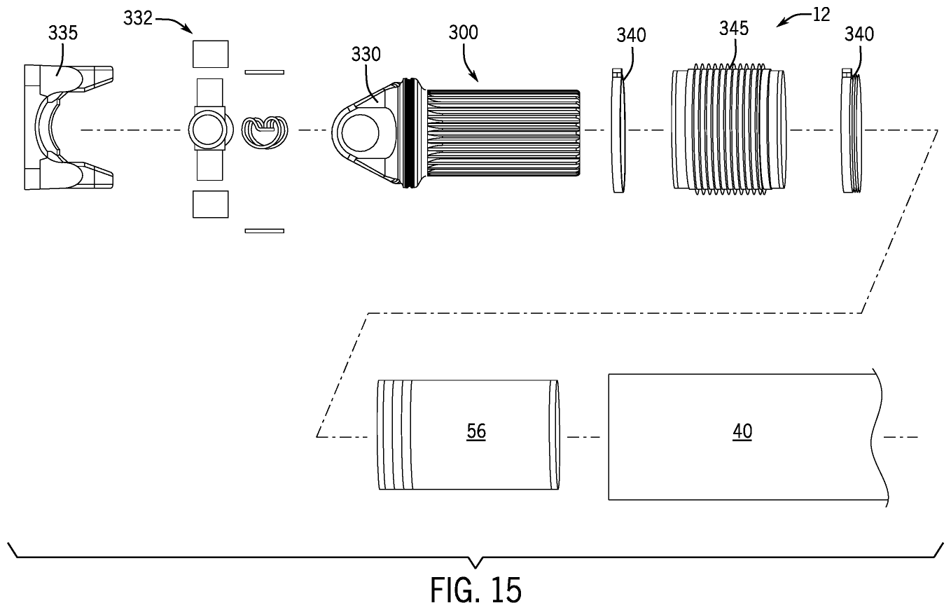

FIGS. 14 and 15 show various exploded views of the slip joint 312 or its components. FIG. 14 shows the slip shaft 300 removed from the sleeve 56, with the length of the slip shaft base splined segment 320 at least as long as a length of the sleeve splined segment 214. FIG. 15 shows yet other components of the slip joint 312 separated from each other. Sleeve 56 is removed from tube 40 toward the lower right-hand side of this view. Toward an upper left-hand side of this view, U-joint 332 is shown disassembled with yoke 335 that connects to the transmission output shaft, the cross-shaped trunnion, end caps that maintain the needle or other bearings against the trunnion, and internal circlips or snap rings that maintain the trunnion within the yokes 335, 330. Bands 340 are at opposite ends of the dustboot 345 that surrounds the slip joint and extends between the slip shaft yoke 330 and sleeve 56.

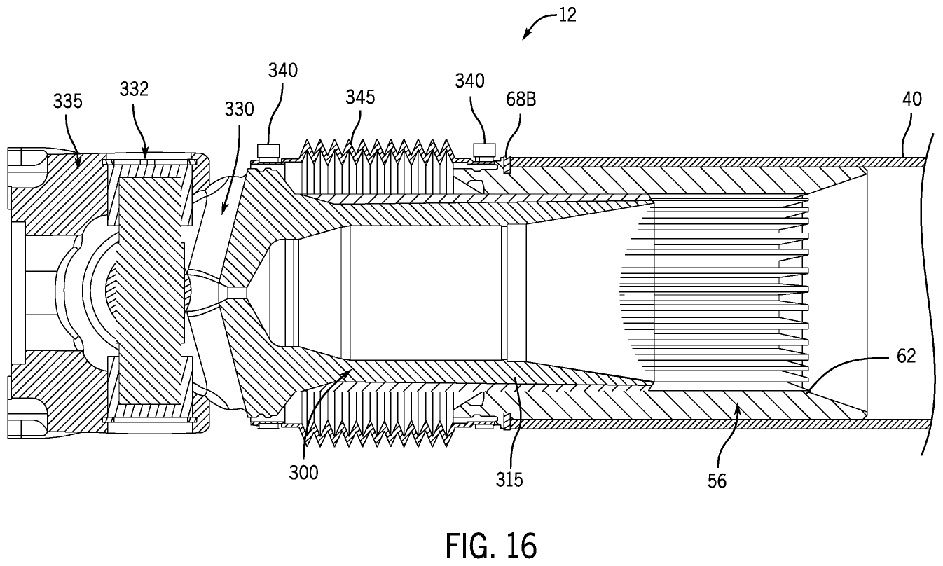

FIG. 16 shows the assembled slip joint 312. At least ⅓, for example, about ½ of the length of the slip shaft splined shaft 315 extends into the splined segment of sleeve 56, when in a neutral position. This partial length splined engagement allows for both lengthening and shortening of the driveshaft assembly 10 during, for example, articulation of suspension components that causes driveshaft assembly 10 to pivot about the front U-joint 332. The overall width or diameter of the slip shaft yoke 330 and an outer end of sleeve 56 is substantially the same. A base of the slip shaft yoke 330 and the outer end of sleeve 56 are shown with alternating groups or protrusions that provide an undulating surface against which outer ends of dust boot 345 may be seated, as tightened by bands 340.

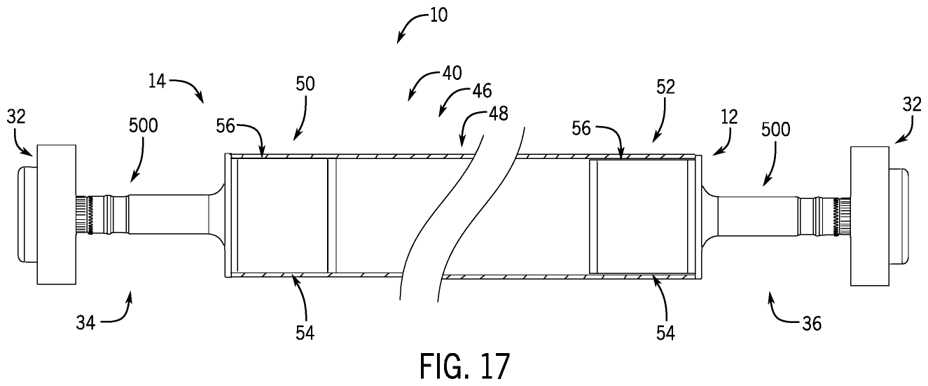

Referring generally to FIGS. 17-24, various components of a modular end assembly embodiment are shown, with numerous components, structures, and features of that are common with or substantially analogous to those of the flex plate embodiment(s) of FIGS. 2-9 and the slip joint embodiment of FIGS. 10-16, whereby relevant portions of those descriptions are applicable here with respect to FIGS. 17-24.

Referring now to FIG. 17, in this embodiment, bondable end components 12, 14 are shown here in the form of modular end assemblies 350 that may be implemented as a multi-component arrangement, represented here as implemented as a pair of CV (constant velocity) joints 352 supported by a pair of stub shafts 500. Each modular end assembly 50 has a base shown as a sleeve 56.

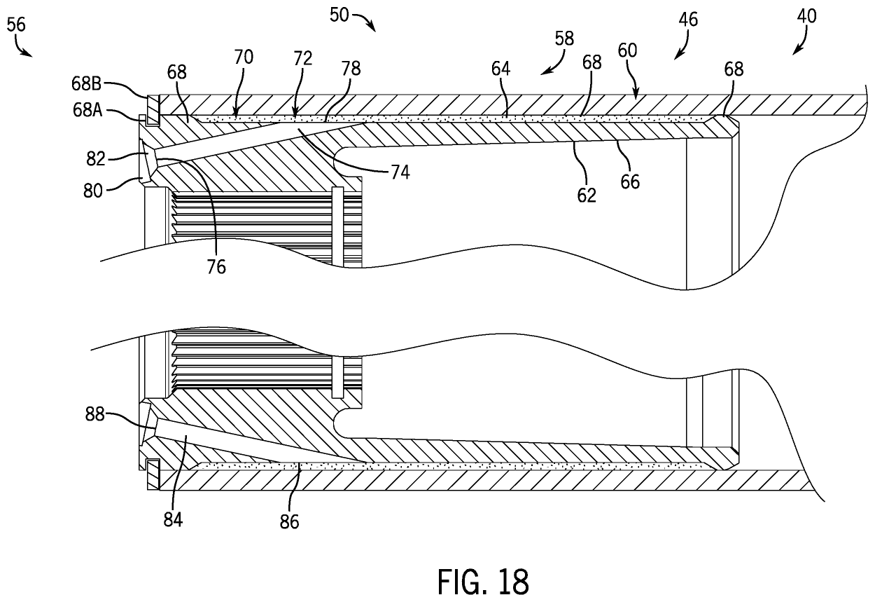

Referring now to FIG. 18, similar to the slip joint embodiment shown in FIG. 11, in this modular end assembly embodiment, a retainer such as an external snap ring 68B may be seated in a groove 68A of an outer land 68 to longitudinally or axially register the sleeve 56 and tube 40 with respect to each other. Yet other retainers or intermediate engaging structures, such as an O-ring or the like, may engage both the sleeve 56 and the tube 40, if the optional longitudinal or axial registration is desired.

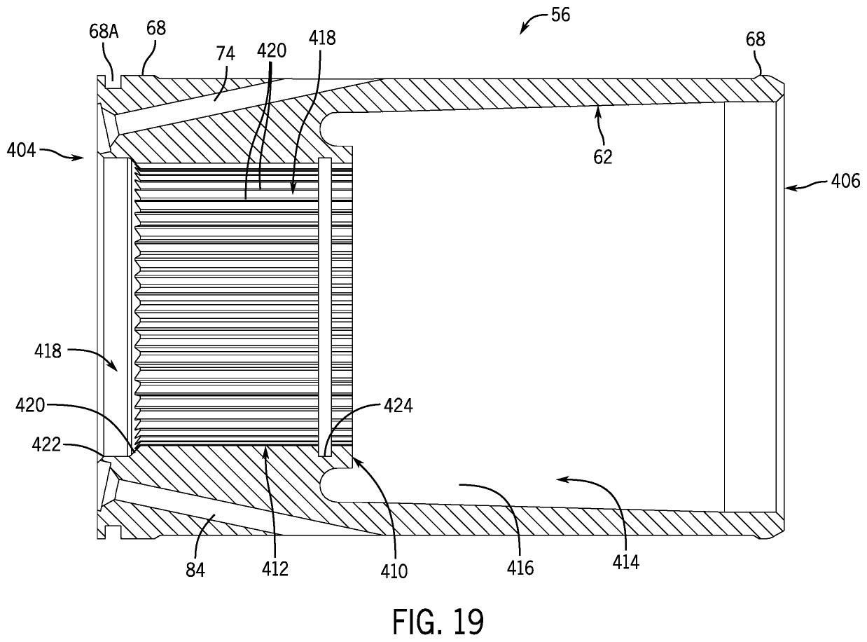

Referring now to FIG. 19, sleeve 56 is shown here as hollow, with an outer end opening 404 and an inner end opening 406 and multiple interior segments that are axially adjacent each other but that are defined by different diameters or steps along the sleeve inner circumferential surface 62. A shoulder 410 is defined at the inner circumferential surface 62 between splined and non-splined segments 412, 414. Shoulder 410 separates a cavity or space as a sleeve interior 416 into a splined chamber 418 that corresponds in location to the splined segment 412 toward the front or outer ends of sleeve 56 with splines 420 that extend into for from the sleeve inner circumferential surface 62. The splines of the splined segment 412 are shown here as straight splines, although it is understood that the splines may have other configurations. For example, the splines may be helical.

Still referring to FIG. 19 toward the outer end opening 404, socket 418 extends from the outer face of sleeve 56 into the splined segment 412. Socket 418 has at least one ramped segment such as an inner taper 420 that presents a conical transitional surface that decreases the diameter of socket 418 to the smaller diameter of splined segment 412. An outer taper 422 provides a conical transitional surface at the outer opening of sleeve 56 that decreases the diameter of the outer opening to the smaller diameter of socket 418. Toward an inner end of splined segment 412, an internal groove 424 is defined by an undercut that extends into the inner circumferential surface of sleeve 56.

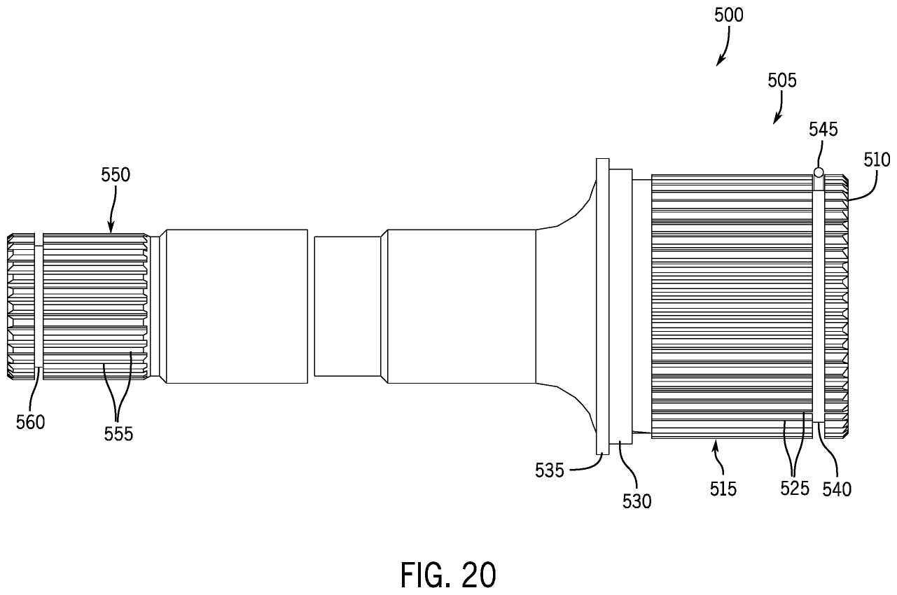

Referring now to FIG. 20, modular end assembly includes a stub shaft 500 that cooperates with the sleeve 56 (FIG. 19) or other base to allow torque transmission through the joint. An inner end of the stub shaft 500 includes a stub shaft base 505, the end of which defines an inner end 510 of stub shaft 500. Stub shaft base 505 includes a stub shaft base splined segment 515 with external splines 525 that extend into or from an outer circumferential surface of stub shaft base splined segment 515. Toward an intermediate portion of stub shaft 500, stub shaft base 505 includes a collar 530 that extends radially from a base bottom surface of the stub shaft base 505. A flange 535 extends radially outward from collar 530. Toward an outer end of the stub shaft base 505, an external groove 540 extends into the circumferential sidewall of the stub shaft base 505, through the splines 525. A spring ring 545 is shown at the top portion of a groove 540. The radial depth of groove 540 is great enough so that, when spring ring 545 is compressed, the spring ring sits entirely below splines 525. An outer end of stub shaft 500 is shown with another splined segment, shown as an outer end splined segment 550, which has a smaller diameter than the inwardly adjacent portion of the main shaft body. External splines 555 extend into or from an outer circumferential surface of stub shaft outer end splined segment 550 and an external groove 560. Groove 560 is shown extending circumferentially into the outer circumferential surface of the outer end splined segment 550 and through the depth of splines 555. Outer end splined segment 550 is configured to connect to a driveline joint, such as CV-joint 332 (FIG. 2) through cooperating splines of such component, which may be further retained by, for example, a snap-ring or the like in the external groove 560 of stub shaft outer end splined segment 550.

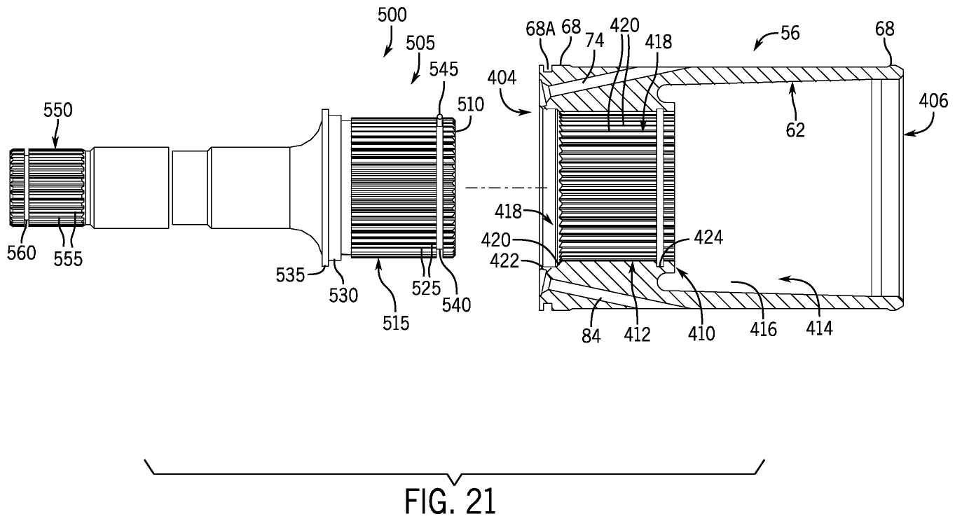

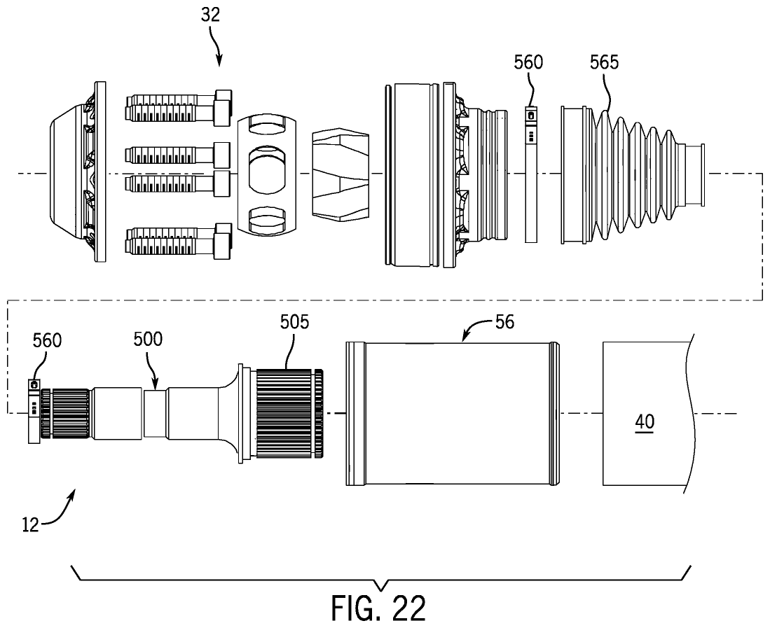

FIGS. 21 and 22 show various exploded views of modular end assembly 12 or its components. FIG. 21 shows the stub shaft 500 removed from the sleeve 56. FIG. 22 shows yet other components of the modular end assembly separated from each other. Sleeve 56 is removed from tube 40 toward the lower right-hand side of this view. Toward an upper left-hand side of this view, CV-joint 332 is shown disassembled with various external or housing components and the internal components shown, including the CV-joint's cap, outer and inner bearing races, bearing cage, boot adapter, and various fasteners. Bands 560 are disposed at opposite ends of a dustboot 565 that surrounds and extends between an inboard end of CV-joint 332 and inner end of stub shaft 500 toward the stub shaft base 505.

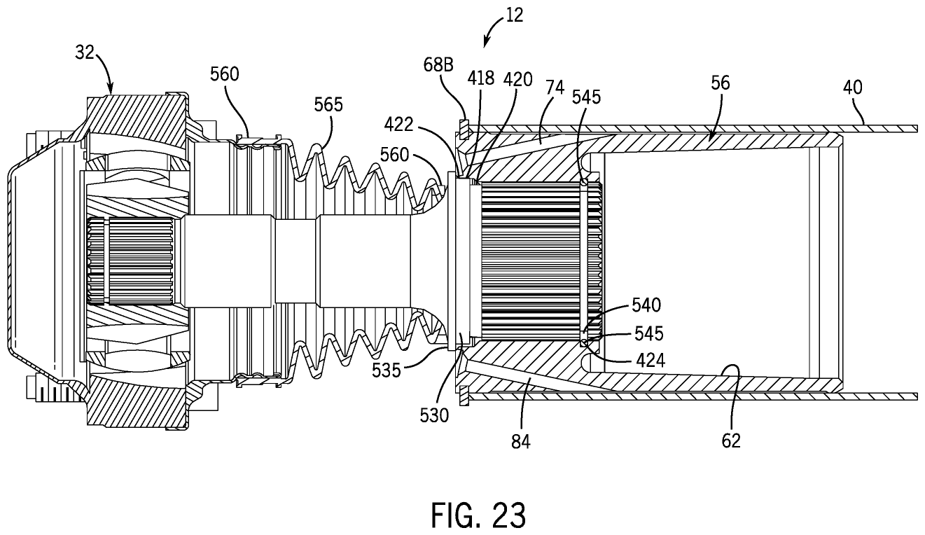

FIG. 23 shows the assembled modular end assembly. Stub shaft 500 is rotationally and axially locked to sleeve 56. The engaged splines of the stub shaft 500 and sleeve 56 lock the stub shaft 500 and sleeve 56 into rotational unison with each other. Spring ring 545 biases outwardly into the internal groove 424 of sleeve 56. The thickness of spring 545 allows its outer portion to be seated in the inner groove 424 of sleeve 56 and its inner portion to be seated in the outer groove 540 of stub shaft 500. This seating prevents axial withdrawal of stub shaft 500 from sleeve 56 by providing a mechanical stop that engages an inwardly facing wall(s) of groove 540.

Still referring to FIG. 23, during installation of stub shaft 500 spring ring 545 automatically compresses to allow insertion of stub shaft 500 and then automatically releases or biases out to axially fix or lock stub shaft 500 with respect to sleeve 56. While installing stub shaft 500 into sleeve 56, the spring ring 545 gets compressed by the ramped segment(s) provided by outer and inner tapers 422, 420 that provide a conical restriction in diameter, starting at the end opening of sleeve 56. Axially advancing stub shaft base 305 into sleeve 56 initially forces outer surface of spring ring 545 to engage with outer taper 422. As stub shaft base 545 axially advances further, the diameter reduction of outer taper 422 forces the spring ring 545 to compress and sit further into groove 540 until the spring ring 545 reaches the constant diameter socket 418, at which time the spring ring 545 maintains the same amount of compression and sits in the same position within groove 540. When spring ring 545 reaches the end of socket 418, the spring ring 545 engages the inner taper 420. The diameter reduction of inner taper 420 forces the spring ring 545 to compress and sit further into groove 540, deep enough to slide below the splines of sleeve 56 while advancing through the sleeve 56, until the spring ring 545 reaches the internal groove 424 of sleeve 56. At that point, spring ring 545 biases concentrically outward to seat into groove 424 of sleeve 56 with its thickness extending into groove 540 of stub shaft 500, mechanically locking sleeve 56 and stub shaft 500 to each other.

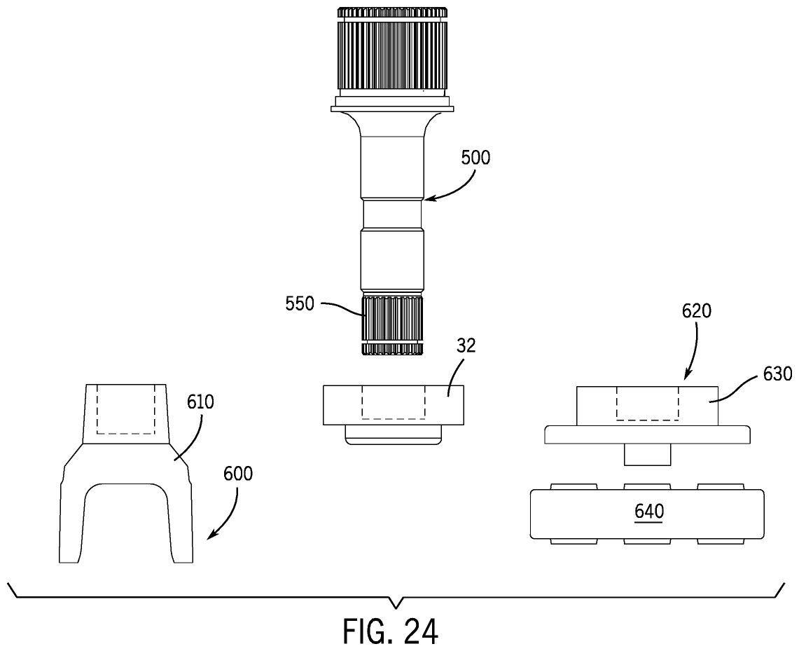

Referring now to FIG. 24, although stub shaft 500 has been described for use with CV joint 332, it is understood that other driveline joints can be implemented with the modular end assembly 12. Examples of other implementations include a U-joint 600 of which a U-joint yoke 410 is attached to the stub shaft outer end splined segment 550 and connects to other U-joint components such as a trunnion that connects to another U-joint yoke. Another example of an alternative driveline joint is a flex joint 620 implementation of which a flex end plate 630 is attached to the stub shaft outer end splined segment 550 and connects to a flex plate 640 or flexible disc such as a guibo disc that attaches to another end plate. It is understood that any of the driveline joint components such as those shown could be integral with the end of stub shaft 500 instead of connected, removably or otherwise, to a stub shaft outer end splined segment 550.

Regardless of the particular driveline joint, the toolless permanent snap-connection of stub shaft 500 to sleeve 56 allows the sleeve 56 to be fully bonded to tube 40 before the stub shaft 500 is installed. This allows modular end assembly to be installed without bulky or otherwise obstructive components potentially blocking or compromising access to, for example, injection ports while delivering adhesive for bonding sleeve 56 to tube 40.

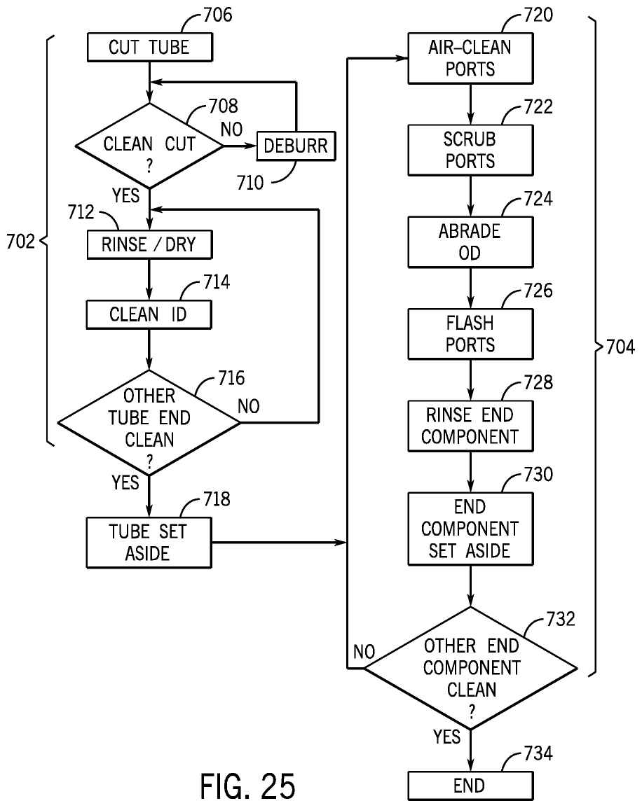

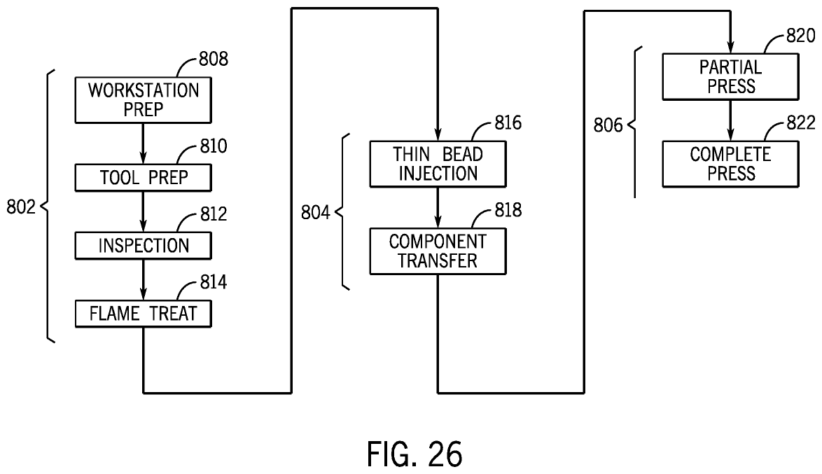

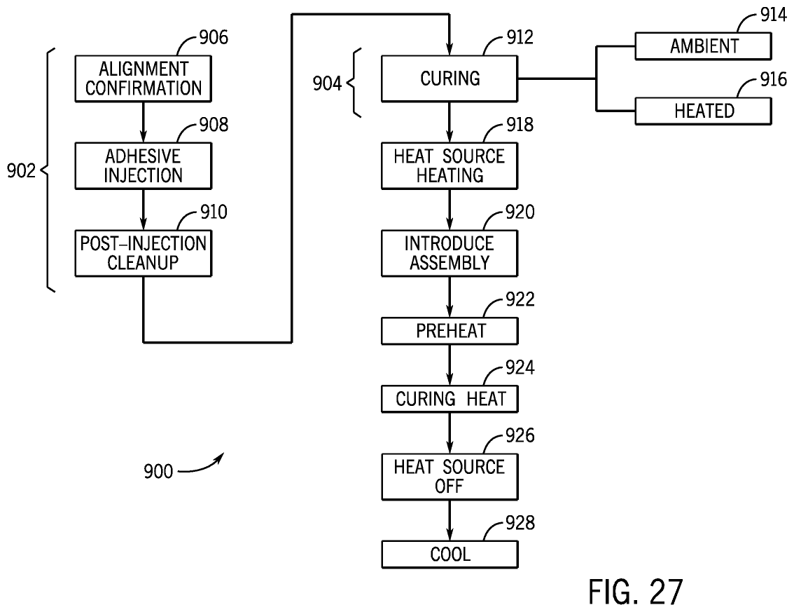

Referring now to FIGS. 25-27, regardless of the particular bondable end component, adhesive injection bore configuration, or the particular type(s) of driveline joints implemented on the composite driveshaft assembly 10, the driveshaft assembly 10 is typically assembled by way of a build procedure with multiple phases, represented as surface preparation phase 700 in FIG. 25, assembly phase 800 in FIG. 26, and bonding phase 900 in FIG. 27. Before beginning the multi-phase build procedure, general workstation preparation is performed. This includes, for example, preparing a build area of the workstation for the multi-phase build procedure by cleaning the build area thoroughly to ensure that any work surfaces that will be used are completely free of oils and debris, whereby debris and oils cannot be seen or felt. If compressed air is using in any of the phases of the multi-phase build procedure, then a user should ensure that the compressed air system that feeds the workstation has an air dryer and filtration system and that such a system is operational to ensure that the compressed air is free of oil and water.

Referring now to FIG. 25, surface preparation phase 700 includes is represented as at least two stages, shown as tube surface preparation 702 and end component surface preparation 704. During tube surface preparation 702, composite tube 40 is cut to length based on the requirements for a particular driveshaft 10 being built, with an appropriate blade, as represented at process block 706. Typically, a rotary-style or other wet saw is used to reduce dust while cutting the composite tube 40. At decision block 708, the cut end of composite tube 40 is inspected for a cleanliness of cut, which should be free of visible burrs or protruding fibers. As represented at process block 710, if present after cutting, burrs or protruding fibers are removed from the end using an appropriate tool such as a file, an abrasive cloth such as an emery cloth, or an abrasive pad such as various ones available from 3M® under Scotch-Brite™ and various other tradenames. If the cut end of composite tube 40 is free of burrs or protruding fibers, then the composite tube's 40 inner circumferential surface or ID (inside diameter) is rinsed, as represented by process block 712. Water is typically used during rinsing to remove any residual carbon dust from the cutting operation. Clean shop towels or the like are typically passed through the composite tube 40 to dry and wipe debris from inside the composite tube 40. The clean shop towel(s) is passed through the bore of the composite tube 40 until minimal debris from the composite tube 40 is found on the shop towel(s). As represented at process block 714, the composite tube's 40 ID is cleaned with a degreaser or solvent, which is typically acetone, for example, applied with a clean cloth such as a new, clean, no-lint shop towel that is wetted with acetone from a plunger can. The ID of the end of composite tube 40 is wiped with the acetone-wetted towel to thoroughly clean the full bond area or the length of the composite tube's 40 ID in which the end component 12, 14 is inserted. Wiping in this manner is repeated, typically with a fresh or new, clean, no-lint shop towel or other appropriate cloth with each of the wipe downs. The cloth is repositioned or replaced during the repeated wiping process until cloth remains clean after wiping. Typically, several (such as three or more) wiping cycles are required removal liquid or solid particle contamination from storage, shipping, and cutting dust and debris. After sufficient cleaning with the wiping cycles, the cloth should be completely free of any visible carbon dust and there should be no visible towel or other cloth lint inside the composite tube 40. As represented at decision block 716, if the other end of composite tube 40 has not yet been cleaned, then the process repeats of rinsing, drying, and cleaning at process blocks 712, 714 for that other end. As represented at process block 718, after the bond areas in both ends 50, 52 of composite tube 40 are cleaned, the composite tube 40 is set aside during the end component surface preparation 704. Setting the composite tube 40 is side is done without touching the inside of the composite tube's ends 50, 52 or otherwise posing contamination risks to the cleaned surface(s). Typically, this is done by moving the composite tube 42 its set aside location by handling only its outer circumferential surface and covering its open ends with a lint-free cloth such as a no-lint shop towel.

Still referring to FIG. 25, during the surface preparation of the bondable end component 12, 14, as represented by process block 720, the end component ports are pneumatically cleared. This is typically done with an aerosol-type canned air product, such as those used for removing dust from electronic components. Other dry and clean compressed air, such as filtered, dry, oil-free, shop air or the like, may also be used. The pneumatic clearing of ports removes, e.g., machining chips, cutting fluid, or other contamination in the injection holes or ports that may have accumulated during the manufacturing process or shipping/storage. As represented at process block 722, the ports are mechanically cleaned, for example, by scrubbing. This is typically done with a pipe cleaner that is sized to apply sufficient wiping engagement and resistance to push through the port while mechanically removing solid debris. As represented at process block 724, the end component's outer circumferential surface or OD (outside diameter) is scuffed or mechanically cleaned. This is typically done by abrading the OD of the inserted section (including the bond area and lands 68, 69) of the end component 12, 14 with a Scotch-Brite™ pad or other suitable abrasive pad. At process blocks 726 and 728, the ports are flushed and the inserted section of the end component 12, 14 is thoroughly rinsed. Both the port flushing and inserted section rinsing is typically done with a degreaser or solvent and more typically with acetone delivered from, for example, an acetone delivery bottle, which is typically a squeeze-type bottle. As represented at process block 730, after the end component's inserted section has been cleaned, the end component 12, 14 is set aside for further processing, such as assembly. Setting aside the end component 12, 14 typically includes placing it at a clean location in the workstation, without touching the inserted section or exposing it to potential contact with any foreign material. During the set aside of the end component 12, 14, if the inserted section is touched or contacts any foreign material, then the process of clearing, scrubbing, abrading, flushing, and rinsing at process blocks 720, 722, 724, 726, 728 is repeated. At decision block 732 if the other end component 12, 14 has not yet been cleaned, then the process repeats of clearing, scrubbing, abrading, flushing, and rinsing at process blocks 720, 722, 724, 726, 728 for such other end component 12, 14. When both end components are cleaned and set aside, the surface preparation phase 700 is complete, as represented at process block 734.

Referring now to FIG. 26, assembly phase 800 is typically performed within 30 minutes and, more typically, within 15 minutes of the surface preparation phase 700 (FIG. 25). Assembly phase 800 is represented as at least three stages, shown as assembly preparation 802, preliminary lubrication 804, and pressing 806. Assembly preparation 802 includes workstation preparation, tool preparation, inspection, and flame treatment, respectively represented at process blocks 808, 810, 812, 814. During workstation preparation at block 808, acetone, shop towels, and/or other flammable materials are moved far away, for example, at least 10 feet, from the work surface and surrounding area. During tool preparation at block 810, an adhesive-delivery gun, such as a pneumatic, electric, or manual hand-held or other adhesive gun, is prepared for the adhesive injection. This typically includes loading an adhesive cartridge into the adhesive gun and removing the cap from the cartridge. One suitable adhesive is available from the 3M Company under the tradename DP460. A mixing nozzle is attached to the cartridge's nozzle. A preliminary activation of the gun is performed to purge the mixing nozzle of air and unmixed adhesive. This is typically done by dispensing a sufficient amount of material from the mixing tube until is yields a uniform color and viscosity. Also, during tool preparation at process block 810, a flame treatment torch is prepared. Typically, the torch is a MAPP gas torch and the preparation includes screwing a bottle of MAPP gas onto an appropriate torch head. During the inspection at process block 812, both the ID of the composite tube 40 and the OD of the bondable end component 12, 14 are inspected to ensure that there is no dust or other debris or contamination in or on either component. If the composite tube 40 and the bondable end component 12, 14 are free of dust, debris, and contamination, then a flame treatment is performed on each, as represented at process block 814.

Still referring to FIG. 26, during the flame treatment 814 of the bondable end component 12, 14, the MAPP gas torch is ignited and its flame is moved uniformly over the OD of the bondable end component's entire bond area to activate the surface of the bond area to optimize adhesion. The blue portion of the flame should contact the surface of the bond area and the bondable end component 12, 14 is rotated while contacting with the flame to ensure complete coverage. The flame treatment is performed without heating the bondable end component's bond area in excess of 160° F. The flame treatment stage is repeated for the second bondable end component 12, 14, the MAPP gas torch is turned off, and the bondable end components are set aside in a clean area. Table 1 shows various examples of suitable flame treatment times for the bondable end component 12, 14 as a function of its size, represented in terms of its OD in inches.

TABLE 1

| | Flame Treatment Time for |
|---|---|
| Bondable End | Bondable End Component's |
| Component Area Size | Inserted Section OD |
| (OD in inches) | (in seconds) |
| 2.0 | 20 ± 5 seconds |
| 2.5 | 20 ± 5 seconds |
| 3.0 | 30 ± 5 seconds |
| 3.5 | 30 ± 5 seconds |
| 4.0 | 40 ± 5 seconds |
| 4.5 | 40 ± 5 seconds |
| 5.0 | 50 ± 5 seconds |

During a flame treatment 814 of the composite tube's 40 end, the MAPP gas torch is re-ignited and its flame is moved uniformly around the ID of the composite tube's bond area to activate the surface of the bond area to optimize adhesion. Movement of the flame is performed continuously, and typically while rotating, so that the flame does not contact any single area of the composite tube for more than one second to reduce the likelihood of damaging the composite tube. The flame treatment is performed without heating the composite tube's bond area in excess of 140° F. while being heated sufficiently to be hot to the touch, typically between 110° F.-140° F., which can be measured with a precision thermometer/thermocouple. The flame treatment stage 814 is repeated for the second end of the composite tube 40. Table 2 shows various examples of suitable flame treatment times for the ends of composite tube 40 as a function of its size, represented in terms of its ID in inches.

TABLE 2

| Tube Size | Flame Treatment Time for Tube ID |
|---|---|
| (ID in inches) | (in seconds) |
| 2.0 | 20 ± 5 seconds |
| 2.5 | 20 ± 5 seconds |
| 3.0 | 30 ± 5 seconds |
| 3.5 | 30 ± 5 seconds |
| 4.0 | 40 ± 5 seconds |
| 4.5 | 40 ± 5 seconds |
| 5.0 | 50 ± 5 seconds |

The flame treatment stage 814 is repeated for the second end of the composite tube. The MAPP gas torch is turned off, and the process advances to the preliminary lubrication stage 804. During the preliminary lubrication stage 804, as represented at process block 816, a thin bead of adhesive is injected around the inside edge of the end of composite tube 40, with the adhesive acting as a lubricant. Using a gloved hand, the adhesive is spread around the ID of the composite tube, in its bond area. Adhesive is spread around this way until the bond area is fully coated to provide full lubrication in the bond area and protect against scratching and dust generation. As represented at process step 418, the bondable end component 12, 14 and the composite tube 40 are transferred to a press-up tool at the workstation. This is done without touching the ID of the composite tube 40 or the OD of the flame-treated bond area of the bondable end component 12, 14. The press-up tool is an industry-standard press-up tool, for example, a driveshaft press, a vertical press, or a lathe. During the pressing stage 806, an initial partial press is performed, as represented at process block 820. This typically includes pressing the bondable end component 12, 14 a small fraction of the way into the end of composite tube 40, such as less than about ⅛ of the way into the tube or far enough for the bondable end component 12, 14 to self-support in the end of composite tube 40. The alignment of the bondable end component 12, 14 is inspected with respect to the composite tube 40 to ensure that the bondable end component is inserting straight and not knocked off center with respect to the composite tube 40. As represented at process block 822, the bondable end component 12, 14 is pressed the remainder of the way into the end of composite tube 40. This typically includes pressing the end component 12, 14 until its shoulder stop or other stop-type structure is fully seated against the end of the composite tube 40.

Referring now to FIG. 27, bonding phase 900 includes an injection stage 902 and a curing stage 904. During injection stage 902, alignment of the bondable end component 12, 14 within the composite tube 40 is confirmed, as represented at process block 906. The bondable end component 12, 14 and composite tube 40 are inspected to ensure that the tube is positioned in a manner that presents the holes of the ports at the end or face of the end component 12, 14 in vertical alignment with each other. As represented at process block 908, active injection of the adhesive is performed. The tip of the mixing nozzle of the adhesive gun is pressed tightly into the lower port of the vertically aligned ports and adhesive is injected into the lower port. Adhesive is injected into the lower port until it begins to bubble out of the upper port. At this point, the tip of the mixing nozzle is held in place without additional adhesive injection for between about 10 seconds to 30 seconds, typically a pause of 15 seconds, to allow any trapped air to escape. Injecting adhesive resumes through the lower port until all of the air is fully purged. A fully purged condition typically corresponds to an absence of any air bubbles through the upper port. As represented at process block 510, any excess adhesive is removed with a cleaner or solvent, such as an acetone-moistened shop towel. A strip of filament tape is placed over the openings of both ports to prevent adhesive leakage from the ports during the curing process or stage 904. As represented at process block 912, the adhesive is cured. Curing can be done in a relatively slower manner at room or ambient temperature, shown at process block 914. Ambient or room temperature curing is done for at least forty-eight hours to ensure a fully cured condition of the adhesive before installing the composite driveshaft assembly 10 into a vehicle. As represented at process block 914, curing can be done in a relatively quicker manner at an elevated temperature, shown at process block 916. Elevated temperature or heated curing is typically done in a large oven or with another heat source. As represented at process blocks 918 and 920, the heat source is activated to begin warming up and the driveshaft assembly 10 or assembly of the end components and the composite shaft 40 is placed in the oven or exposed otherwise exposed to heat from the heat source. This is typically done by preheating the oven or other heat source to 150° F. and then placing the assembly 10 into the oven or arranged with respect to the heat source to be heated by it. As represented at process block 922, the assembly 10 is left in the oven or receives heat from the heat source for between 20 minutes to 45 minutes, typically 30 minutes at 150° F., to raise the temperature of the assembly 10 to the curing temperature. At process block 924, the assembly 10 is heated at the curing temperature for an appropriate amount of time, typically 1 hour at a curing temperature of 150° F. As represented at process blocks 926, 928, the oven or other heat source is turned off or the assembly is removed from the oven or heat source exposure and then the assembly 10 is allowed to cool. The cooling typically takes at least 30 minutes at room or ambient temperature.

Many changes and modifications could be made to the invention without departing from the spirit thereof. The scope of these changes will become apparent from the appended claims.

What is claimed is:

1. A composite vehicle driveshaft comprising:
a composite tube, the composite tube being formed from wound filaments and a resin material and having inner and outer peripheral surfaces and inner and outer axial ends; and
an end component including an outer coupler and an inner sleeve that is concentrically received in one of the input and output ends of the tube, the sleeve having an outer peripheral surface that faces the inner peripheral surface of the tube with a cavity formed therebetween, an adhesive injection passage being formed in the end component, wherein the adhesive injection passage extends at an acute angle from an inlet that is formed in an axial surface of the end component to an outlet that is formed in the outer peripheral surface of the sleeve and that opens into the cavity.

2. The composite driveshaft assembly of claim 1, wherein the end component comprises a yoke configured to connect to a powertrain component of a vehicle.

3. The composite driveshaft assembly of claim 2, wherein the yoke is defined by a flex plate end yoke.

4. The composite driveshaft assembly of claim 3, wherein the cavity is sealed at inner and outer axial ends thereof by structures extending between the outer peripheral surface of the sleeve and the inner peripheral surface of the tube.

5. The composite driveshaft assembly of claim 4, wherein the structures comprise lands formed on the outer peripheral surface of the sleeve.

6. The composite driveshaft assembly of claim 3, wherein the acute angle is between 5 degrees and 20 degrees.

7. The composite driveshaft assembly of claim 3, wherein the injection passage is circular in transverse cross section and the outlet opening is elliptical in shape.

8. The composite driveshaft assembly of claim 3, wherein the flex plate end yoke has a central hub and radial flanges that extend radially outwardly from the hub and that are configured for connection to a flex disk.

9. The composite driveshaft assembly of claim 1, wherein the end component comprises a slip joint arranged at an end of the composite tube and including:
a slip shaft that is:
locked in rotational unison with the sleeve and composite tube; and
axially translatable with respect to the sleeve and composite tube.

10. The composite driveshaft of claim 9, wherein the slip shaft defines a slip shaft base that engages the sleeve to axially translate with respect to and rotate in unison with the sleeve.

11. The composite vehicle driveshaft of claim 10, wherein the slip shaft base comprises a splined shaft with external splines and the sleeve defines internal splines that receive the external splines of the splined shaft.

12. A method of bonding a flex plate end yoke of composite driveshaft assembly to a composite tube of the composite driveshaft assembly, the method comprising:
injecting an adhesive at an acute angle from an axial surface of the flex plate end yoke, through an opening in an outer peripheral surface of a sleeve of the flex plate end yoke, and into a cavity formed between the outer peripheral surface of the sleeve of the flex plate end yoke and an inner peripheral surface of the composite tube; and
allowing the adhesive to cure.

13. A composite vehicle driveshaft assembly, comprising:
a composite tube having opposed tube ends and that define a tube sidewall that extends axially between the tube ends and that is made from a composite material;
a modular end assembly arranged at an end of the composite tube and including:
a sleeve that is concentrically attached to the end of the composite tube;
a stub shaft locked in rotational unison with the sleeve and the composite tube.

14. The composite vehicle driveshaft assembly of claim 13, wherein the stub shaft is axially locked in the sleeve.

15. The composite vehicle driveshaft assembly of claim 14, wherein the stub shaft comprises:
an inner end that is axially locked in the sleeve; and
an outer end that is removably connected to a component of a driveline joint.
